(19) United States
(12) Patent Application Publication
(10) Pub. No.: US 2012/0120465 A1
(43) Pub. Date: May 17, 2012

(54) DEVICE AND METHOD OF MARKING A SET OF PRODUCTS

(75) Inventors: Christophe Martinez, Grenoble (FR); Alain-Marcel Rey, Mours St. Eusebe (FR)

(73) Assignee: Commissariat a l"Energie Atomique et aux Energies Alternatives, Paris (FR)

(21) Appl. No.: 13/144,126

(22) PCT Filed: Jan. 12, 2010
(86) PCT No.: PCT/FR2010/050041

§ 371 Date: Oct. 11, 2011

(30) Foreign Application Priority Data
Jan. 14, 2009 (FR) 0950183

(51) Int. Cl. G03H 1/00; B23K 26/00; B23K 15/00

(52) U.S. Cl. 359/2; 219/121.2; 219/121.69

(57) ABSTRACT

The invention relates to a method of marking a batch of products, consisting in forming a synthetic hologram of an image (20) on each product, said hologram being furthermore encoded using a phase key, the image comprising a first portion (22) common to the various products of the batch and a second portion (24) that differs from one product to another.

### FIELD OF THE INVENTION

The present invention relates to a device and a method for marking a set of products, for example to detect counterfeit goods. More specifically, the present invention relates to a marking method and device enabling to properly trace the products.

### DISCUSSION OF PRIOR ART

In many fields, especially in the luxury goods industry (for example, perfumery, jewelry or leather goods), or in the field of drugs, fighting against the imitation of branded products is an everyday concern. Several methods are currently used to attempt to guarantee the authenticity of branded products. The simplest is to reproduce or to affix a brand logo on the products. However, an ill-intentioned person can easily reproduce a logo.

Other marking methods, which are more difficult to detect and to copy, are known. One of them comprises placing an identification chip, invisible for the naked eye, on each of the products of a batch. For this chip to be invisible, a hologram may be formed on a transparent chip placed on the products. The hologram may be obtained by calculating the Fourier transform of an image representing, for example, the brand logo. The origin of the products is thus guaranteed by the presence or the absence of the hologram.

FIG. 1 illustrates an example of a product on which are placed marking or identification chips which may or not be visible.

A bottle 10, for example, for perfume, is formed of a container 12 and of a cap 14. In the shown example, two chips 16 are placed on bottle 10, one on container 12 and the other on or inside of cap 14. Chips 16 are formed of a thin transparent plate on which is formed a hologram 18.

Identification chips such as chips 16 of FIG. 1 may be placed on any type of product, for example, on a watch glass. Generally, the marking must be as inconspicuous as possible, to avoid altering the aspect of the object and to avoid for the marking to be detected.

A disadvantage of known hologram marking structures, even invisible and miniature, is that a person knowing the existence of the marking may, with appropriate means and by reverse engineering, obtain the initial image of the marking by studying the hologram and thus reproduce the hologram on copied products.

U.S. Pat. No. 5,801,857 describes a method for marking products, especially bank cards. This method comprises gluing, on each card of a batch of bank cards, a label comprising a hologram. The hologram is the same on each label. An image is superposed to the hologram to differentiate the labels from one another and thus individualize the card marking. However, such a marking may be easily detected and reproduced.

### SUMMARY

An object of an embodiment of the present invention is to provide a method for marking a batch of products with a coded hologram, for which the decoding by a third party is impossible.

Another object of an embodiment of the present invention is to provide a method for marking by coded hologram in which the reproduction, even accurate, of the hologram is detectable.

Thus, an embodiment of the present invention provides a method for marking a batch of products comprising the forming of a synthetic hologram of an image on each product, said holo-gram being further coded by means of a phase key, the image comprising a first portion common to the different products of the batch and a second portion different from one product to another.

According to an embodiment of the present invention, the hologram is formed by an etching by electron beam or laser.

According to an embodiment of the present invention, the second portion of the image comprises a set of figures and/or letters incremented from one product to another, in a bar code or a data matrix.

According to an embodiment of the present invention, the coded synthetic hologram is directly formed on the product.

According to an embodiment of the present invention, the coded synthetic hologram is formed on a chip placed on the product.

According to an embodiment of the present invention, the chip has a surface area smaller than 1 cm² and is formed of a thin etched platinum oxide layer.

An embodiment of the present invention provides a method for detecting products likely to be copies and supporting coded synthetic holograms, comprising sampling at least two products; decoding, by means of an adapted phase key, the synthetic holograms of the products; and verifying whether the images obtained by the decoding comprise a reference difference.

### BRIEF DESCRIPTION OF THE DRAWINGS

The foregoing and other objects, features, and advantages of the present invention will be discussed in detail in the following non-limiting description of specific embodiments in connection with the accompanying drawings:

FIG. 1, previously described, illustrates an example of a product on which is placed a marking enabling to authenticate it;

FIG. 2 illustrates an example of an image enabling to form a hologram according to an embodiment of the present invention;

FIG. 3 is a flowchart of a method for forming a chip containing a hologram according to an embodiment of the present invention;

FIG. 4 illustrates an example of an etching device enabling to form chips containing holograms;

FIGS. 5A and 5B illustrate an example of a hologram obtained from an initial image such as that in FIG. 2;

FIG. 6 illustrates a comparison between the two holograms obtained from two images such as that in FIG. 2;

FIG. 7 illustrates an example of a device for reading in transmission a coded synthetic hologram; and

FIG. 8 illustrates an example of a device for reading in reflection a coded synthetic hologram.

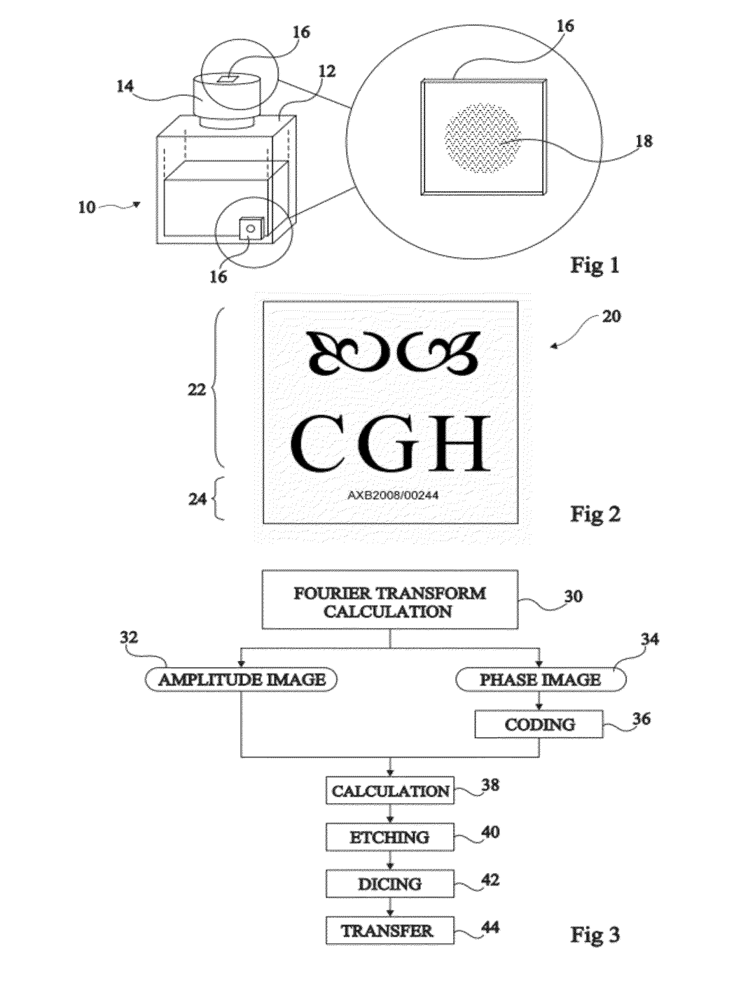

For clarity, the same elements have been designated with the same reference numerals in the different drawings and, further, the various drawings are not to scale.

### DETAILED DESCRIPTION

The inventors provide a device and a method for marking a product, the copying of this marking being easily detectable. To achieve this, the inventors provide placing, on all the products of a batch, a chip, transparent or not, containing a coded hologram, the coding of the hologram comprising a step involving a phase key. The decoding of the hologram is then impossible without using the phase key used for the coding. Further, the inventors provide a hologram for which a direct copy, even very accurate, is detectable. To achieve this, the inventors provide forming a hologram from an initial image comprising two portions: a first portion common to the different products of the batch and a second portion different from one product to another. Thus, a copy, even very accurate, of the hologram present on a product and the reproduction of this holo-gram on several other products are detectable. For this purpose, it is sufficient to verify that, on the products, the image portion reconstructed from the hologram, intended to be different between two products, is actually identical.

FIG. 2 illustrates an example of an initial image in two portions according to an embodiment.

Initial image 20 comprises a first portion 22 and a second portion 24. First portion 22 comprises, in the shown example, a logo and initials (CGH). Second portion 24 comprises a sequence of figures and of letters (“AXB2008/00244”) which is different for each product, and thus for each hologram. For example, the second portion may be a serial number incremented for each product, a bar code, or again a data matrix.

FIG. 3 is a block diagram illustrating an embodiment of a method for forming a chip containing a hologram, in the present case a coded synthetic hologram, on a product.

A first step 30 comprises calculating the Fourier transform of an initial image, such as image 20 of FIG. 2, to obtain images 32 and 34. The first image 32 shows the amplitude of the Fourier transform and second image 34 shows the phase of the Fourier transform.

A step 36 comprises coding phase image 34 by means of a phase key. The phase key is formed of a pattern having its lines corresponding to phase-shift areas of image 34. The same phase key is then necessary to decode the hologram formed.

At a next step 38, an image gathering image 32 and the image obtained in step 36 of coding of phase image 34 is calculated. The calculation may be performed in different known fashions, for example, by following the holographic calculation method discussed in publication “Binary Fraunhofer holograms, generated by computer” by A. W. Lohmann and D. P. Paris, Appl. Opt., 1967, pp. 1739-1748. This method comprises associating, with each pixel of the hologram image, an opaque area comprising an opening of variable size according to the pixel amplitude and more or less centered according to the pixel phase. According to the calculation performed, pixels having a large number of possible states that may be assimilated to different grey levels (for example, 256) are formed. As non-limiting examples, images 32 and 34, and thus the obtained coded holograms, may comprise 500×500 pixels, 800×800 pixels, or again 1000×1000 pixels. The association of coding and calculation steps 36 and 38 provides a hologram which is currently called coded synthetic hologram.

The time taken by the coding and the calculation of a hologram depends on the number of pixels that it comprises. For example, the time taken by the coding and the calculation of a hologram comprising 500×500 pixels lasts for approximately 0.1 s, with the Matlab program, on a personal desktop computer of 64-bit Dell Precision 490 MT Dual Core Xeon 515 type.

At a next step 40, the hologram obtained by the coding is etched either on a chip or directly on an object. The etching may be performed by electron beam or laser beam, which provides an accuracy greater than a fraction of a micrometer. As an example, for a hologram comprising 500×500 pixels, the etching may be carried out on a 1.25×1.25-mm chip. The etched chips preferably have a surface area smaller than 1 cm². By laser beam etching, approximately 200 are etched in approximately 30 minutes, that is, a few seconds per chip. An electron beam etching provides similar results. Thus, the calculation time is negligible as compared with the etch times. The method provided herein is thus advantageously no more time-consuming than known methods for forming holograms on wafers.

Preferably, before etch step 40, steps 30 to 38 are repeated several times to obtain a set of coded synthetic holograms corresponding to different initial images different from one another in their portions 24. Many chips to be placed on the objects to be marked can then be obtained in a single wafer etch step, each chip comprising a different hologram.

At a next step 42, the different chips are diced, after which, at a step 44, they are affixed on the products to be authenticated. As an example, the chips may be affixed on the products by molecular bonding.

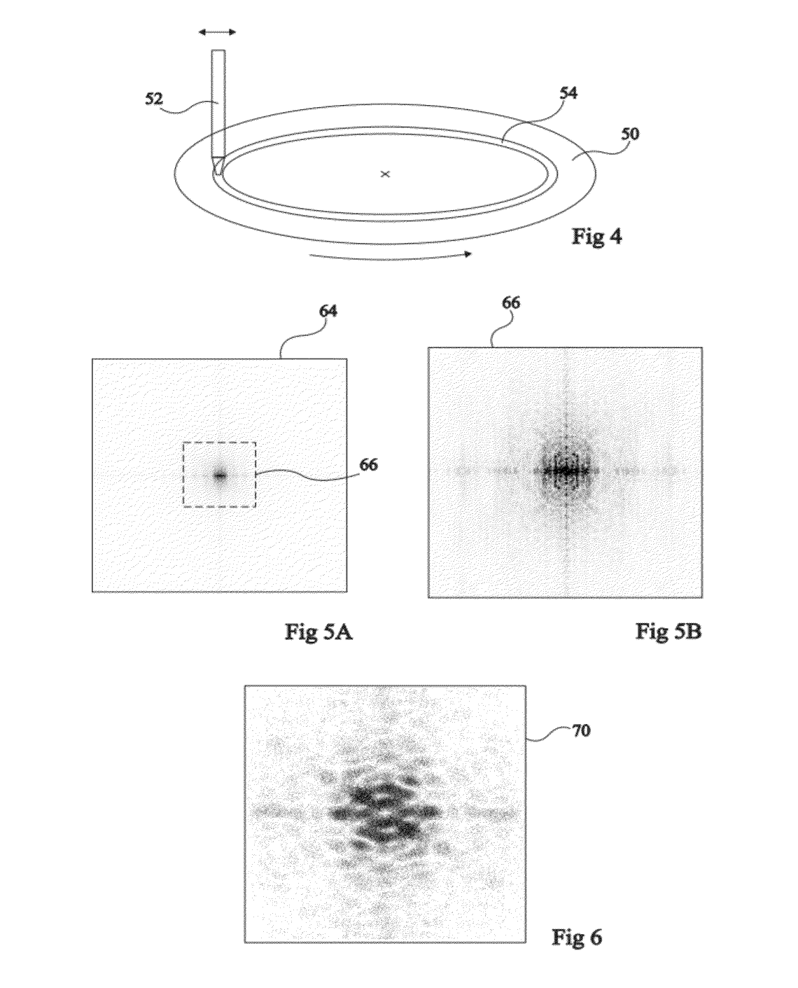

FIG. 4 illustrates an example of an etching device enabling to form chips containing holograms. A wafer 50 on which the holograms are desired to be formed extends on a turntable (not shown). A point 52 enabling an etching, by electron beam or by laser, is aligned with wafer 50. Point 52, mobile along the diameter of wafer 50, enables an etching on a thin circular strip 54 of wafer 50. When wafer 50 is rotated, point 52 is placed in front of different portions of strip 54. Thus, strip 54 is etched, after which etch point 52 is displaced on a strip parallel to strip 54. The passing from one strip to the other may also be continuous: the point then follows a spiral course on the wafer. For example, the wafer may be a glass wafer on which a platinum oxide layer is formed. Under a laser insolation, the thermal effect transforms the platinum oxide into platinum which is then removed by chemical etching. Platinum oxide being a reflective material, the hologram can then operate in reflection or in transmission. It should be noted that this process is an example only and that many etch processes may be used to form the holograms.

FIG. 5A illustrates a coded synthetic hologram 64 obtained by the method of FIG. 3 based on an image such as that in FIG. 2. FIG. 5B is an enlargement of central portion 66 of the hologram of FIG. 5A where the areas to be etched are concentrated.

The hologram shown in FIGS. 5A and 5B comprises a strongly marked central region and more lightly marked peripheral regions. It should be noted that the coded synthetic hologram is not representative of the initial image used to form it since, by Fourier transform, all the elements of the initial image are distributed throughout the hologram. However, a detail of small dimensions present in the initial image is distributed throughout the entire hologram. Thus, it is impossible to reconstruct, from two holograms corresponding to two slightly different images (different serial numbers, for example), the initial images used. Further, advantageously, if a hologram comprises an imperfection, for example, a speck of dust or a thin scratch, this imperfection is, at the decoding, distributed throughout the image obtained by the decoding. Thus, the holo-gram coding is very robust.

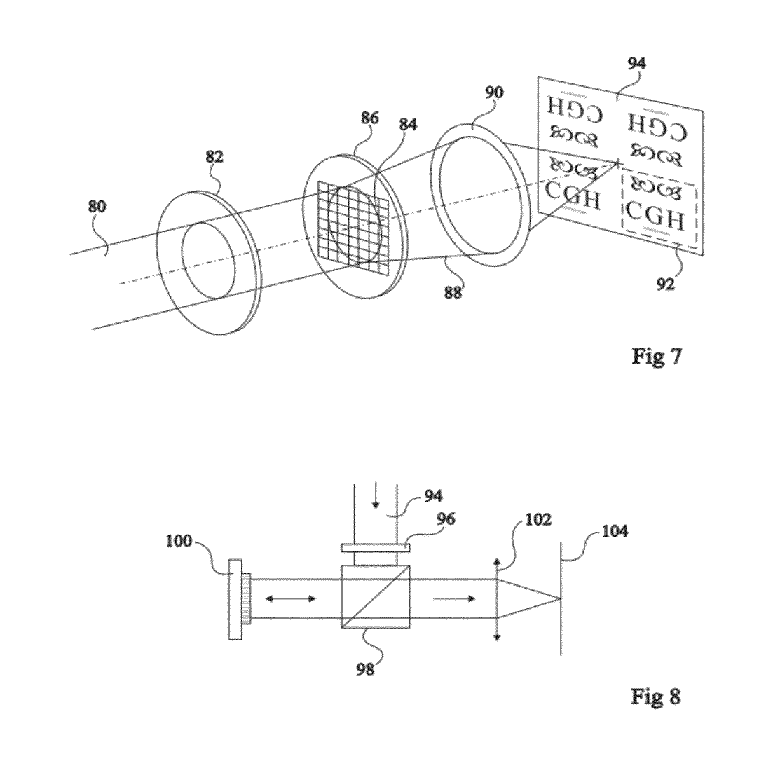

FIG. 6 illustrates the difference between two central portions of two holograms obtained for two slightly different images, for example, two images such as those of FIG. 2 with a different of one figure in the serial number. The case where the resolution is 800×800 pixels is considered.

In difference image 70, each grey-colored pixel corresponds to a pixel for which the difference between the corresponding pixels of the two considered holograms is smaller than the maximum error value equal to 2.3%, that is, smaller than 6 grey levels if the coding comprises 256 grey levels. It should be noted that the grey-colored pixels are distributed substantially across the entire surface of the image and that the maximum error remains low. Thus, a small modification of the initial image is distributed throughout the entire obtained hologram. It is thus impossible to reconstruct, from several holograms, a hologram having its different portion 24 incremented artificially.

A counterfeiter who detects the presence of a hologram on the product and who attempts to decode it will not succeed due to the use of the phase key. The difference between two obtained holograms of two slightly different images does not enable to know the coding technique either. The only remaining solution to copy a marking by a synthetic hologram then is to directly copy, as accurately as possible, the hologram formed on the object. The inventors have noted that an imperfect copy of the hologram can easily be detected since the image decoded from such a hologram is blurred and of poor quality.

Even if a counterfeiter is able to perfectly copy the coded synthetic hologram, such a copy of the hologram can also be detected. Indeed, to achieve this, it is sufficient to seize two copied products and to decode the synthetic holograms formed on these products. If the serial numbers of the images obtained by decoding are identical, this means that the holograms are copies.

FIG. 7 illustrates an example of a device enabling to decode and to read a coded synthetic hologram.

A transmission reading device is here considered. A light beam 80 crosses a blade 82 comprising the phase key used for the decoding, and then crosses hologram 84 formed on a chip 86. Beam 88 diffracted by the hologram 84 crosses a lens 90 which enables the forming of decoded image 92 in a plane 94. Due to the sampling of the hologram, several images are reconstructed in plane 94. The camera performing the acquisition selects a single one.

FIG. 8 illustrates an example of a device for reading, in reflection, a coded synthetic hologram.

A laser beam 94 crosses a blade containing a phase key 96 then enters a beam splitter 98. Splitter 98 provides a beam, perpendicular to beam 94, towards synthetic hologram 100. The beam reflected by synthetic hologram 100 reenters beam splitter 98 to reach a lens 102 which enables to form the decoded image in a read plane 104. Preferably, beam splitter 98 is positioned on a mobile support enabling to accurately illuminate hologram 100.

It should be noted that the alignment of the phase key and of the hologram must be accurate in order to obtain the decoded image from the hologram. For this purpose, the hologram may comprise characteristic points making this alignment possible.

Specific embodiments of the present invention have been described. Various alterations and modifications will occur to those skilled in the art. In particular, it should be noted that the read devices illustrated in FIGS. 7 and 8 are examples only and that any adapted read device may be used to decode the synthetic holograms described herein.

1. A method for marking a batch of products comprising the forming of a synthetic hologram of an image on each product, said hologram being further coded by means of a phase key, the image comprising a first portion common to the different products of the batch and a second portion different from one product to another.

2. The method of claim 1, wherein the hologram is formed by an etching by electron beam or laser.

3. The method of claim 1 wherein the second portion of the image comprises a set of figures and/or letters incremented from one product to another, in a bar code or a data matrix.

4. The method of claim 1, wherein the coded synthetic hologram is directly formed on the product.

5. The method of claim wherein the coded synthetic hologram is formed on a chip placed on the product.

6. The method of claim 5, wherein the chip has a surface area smaller than 1 cm² and is formed of a thin etched platinum oxide layer.

7. A method for detecting products likely to be copies and supporting coded synthetic holograms, comprising:
sampling at least two products;
decoding, by means of an adapted phase key, the synthetic holograms of the products; and
verifying that the images obtained by the decoding comprise a reference difference.
